(19) United States
(12) Patent Application Publication
(10) Pub. No.: US 2019/0378349 A1
(43) Pub. Date: Dec. 12, 2019

(54) VEHICLE REMAINING USEFUL LIFE PREDICTION

(71) Applicant: GM GLOBAL TECHNOLOGY OPERATIONS LLC, Detroit, MI (US)

(72) Inventors: Yuhang Liu, Madison, WI (US); Xinyu Du, Oakland Township, MI (US)

(73) Assignee: GM GLOBAL TECHNOLOGY OPERATIONS LLC, Detroit, MI (US)

(21) Appl. No.: 16/002,546

(22) Filed: Jun. 7, 2018

(51) Int. Cl. G07C 5/00; G07C 5/08

(52) U.S. Cl. CPC G07C 5/006; G07C 5/0808

(57) ABSTRACT

Methods and systems are provided for monitoring a vehicle. In one embodiment, a method includes: receiving data including at least one of vehicle parameters and vehicle diagnostic data; determining, by a processor, a vehicle condition based on a model of vehicle health and the received data; determining, by the processor, remaining useful life data associated with the vehicle based on a first statistical model when the vehicle condition is determined to be healthy; determining, by the processor, remaining useful life data associated with the vehicle based on a second statistical model when the vehicle condition is determined to be unhealthy; and selectively generating, by the processor, notification data based on the vehicle condition and the remaining useful life data.

### BACKGROUND

The present disclosure generally relates to vehicles and more particularly relates to methods and systems for determining and reporting a remaining useful life of a vehicle.

Vehicle components are monitored for faults and the faults are reported once they are diagnosed. For example, a diagnostic code is set which activates a service engine soon light. Some vehicle components, such as engine oil and/or air filters, are monitored for the purpose of determining a useful life of the system. The useful life remaining is reported as it is computed. The reported useful life gives an indication of how long the component has until it needs to be replaced.

It would be desirable to provide useful life information to a user for the vehicle. For example, the remaining useful life information would give an indication of how long until the vehicle stops working. Accordingly, it is desirable to provide methods and systems for determining a remaining useful life of a vehicle. It is further desirable to provide methods and systems for reporting the remaining useful life to a user in a manner that is user configurable. Furthermore, other desirable features and characteristics of the present invention will become apparent from the subsequent detailed description of the invention and the appended claims, taken in conjunction with the accompanying drawings and this background of the invention.

### SUMMARY

Methods and systems are provided for monitoring a vehicle. In one embodiment, a method includes: receiving data indicating a vehicle condition; receiving data including at least one of vehicle parameters and vehicle diagnostic data; determining, by a processor, a vehicle condition based on a model of vehicle health and the received data; determining, by the processor, remaining useful life data associated with the vehicle based on a first statistical model when the vehicle condition is determined to be healthy; determining, by the processor, remaining useful life data associated with the vehicle based on a second statistical model when the vehicle condition is determined to be unhealthy; and selectively generating, by the processor, notification data based on the vehicle condition and the remaining useful life data.

In various embodiments, the method further includes updating the second statistical model based on service event data from the first vehicle. In various embodiments, the method further includes updating the second model based on service event data collected from at least one other vehicle.

In various embodiments, the method further includes presenting the notification data based on a user selected notification template. In various embodiments, the method further includes storing a plurality of notification templates and wherein the user selected notification template is selected from the plurality of notification templates based on user selection data.

In various embodiments, the first statistical model and the second statistical model are based on a proportional hazards model. In various embodiments, the method further includes adapting at least one coefficient of the proportional hazards model based on event data from the first vehicle and other vehicles.

In various embodiments, the notification data includes a percent chance to survive and an associated date. In various embodiments, the notification data includes a failure day. In various embodiments, the notification data includes a graph of survival probabilities.

In another embodiment, a computer implemented system is provided for monitoring a vehicle. The system includes: a data storage device configured to store a model for determining a vehicle health condition, a first statistical model for computing remaining useful life data, and a second statistical model for computing remaining useful life data; and a processor configured to receive data including at least one of vehicle parameters and vehicle diagnostic data, determine a vehicle condition based on the model and the received data, determine remaining useful life data associated with the vehicle based on the first statistical model when the vehicle condition is determined to be healthy, determine remaining useful life data associated with the vehicle based on the second statistical model when the vehicle condition is determined to be unhealthy, and selectively generate notification data based on the vehicle condition and the remaining useful life data.

In various embodiments, the processor is further configured to update the second statistical model based on service event data from the first vehicle. In various embodiments, the processor is further configured to update the second statistical model based on service event data collected from at least one other vehicle.

In various embodiments, the processor is further configured to present the notification data based on a user selected notification template. In various embodiments, the data storage device is further configured to store a plurality of notification templates and wherein the user selected notification template is selected from the plurality of notification templates based on user selection data. In various embodiments, the first statistical model and the second statistical model are based on a proportional hazards model.

In various embodiments, the processor is further configured to adapt at least one coefficient of the proportional hazards model based on event data from the first vehicle and other vehicles.

In various embodiments, the notification data includes a percent chance to survive and an associated date. In various embodiments, the notification data includes a failure day. In various embodiments, the notification data includes a graph of survival probabilities.

### DESCRIPTION OF THE DRAWINGS

The present disclosure will hereinafter be described in conjunction with the following drawing figures, wherein like numerals denote like elements, and:

FIG. 1 is an illustration of a vehicle that includes, among other features, a vehicle monitoring system in accordance with various exemplary embodiments;

FIGS. 2, 3, and 4 are illustrations of notification interfaces that may be generated by the vehicle monitoring system in accordance with various exemplary embodiments;

FIG. 5 is a dataflow diagram of a control module of the vehicle monitoring system in accordance with various exemplary embodiments;

FIG. 6 is a flowchart illustrating a method for monitoring the vehicle in accordance with various exemplary embodiments; and

FIGS. 7, 8, and 9 are illustrations of graphs produced by the models of the vehicle monitoring system in accordance with various exemplary embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to an application specific integrated circuit (ASIC), an electronic circuit, a processor (shared, dedicated, or group) and/or memory that executes or stores one or more software or firmware programs, a combinational logic circuit, and/or other suitable components that provide the described functionality.

Embodiments of the invention may be described herein in terms of functional and/or logical block components and various processing steps. It should be appreciated that such block components may be realized by any number of hardware, software, and/or firmware components configured to perform the specified functions. For example, exemplary embodiments may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that exemplary embodiments may be practiced in conjunction with any number of control systems, and that the vehicle systems described herein are merely exemplary embodiments.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in various embodiments.

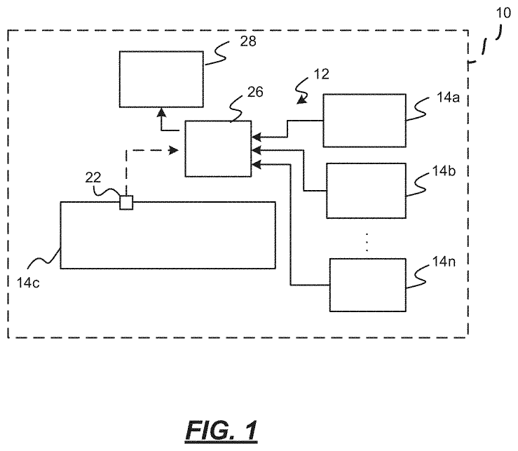

Referring now to FIG. 1, a vehicle 10 is shown to include a vehicle monitoring system 12 that monitors vehicle systems 14a-14n of the vehicle 10 in order to predict and notify a user of a remaining useful life of the vehicle 10. Although the figures shown herein depict an example with certain arrangements of elements, additional intervening elements, devices, features, or components may be present in actual embodiments. It should also be understood that FIG. 1 is merely illustrative and may not be drawn to scale.

As depicted in FIG. 1, at least one of the vehicle sub-systems 14a-14n includes a battery system 14c. The battery system 14c provides power to one or more components of the vehicle 10. In various embodiments the battery system 14c includes vehicle batteries that provide power to a starter, lights, infotainment systems, etc. In various embodiment, the battery system 14c includes batteries that provide power to a motor. As can be appreciated, the vehicle sub-systems 14a-14n can be any systems of a vehicle 10 and are not limited to the current battery system 14c example. As can further be appreciated, the vehicle 10 may be any vehicle type including an automobile, an aircraft, a train, a watercraft, or any other vehicle type. For exemplary purposes, the disclosure will be discussed in the context of the vehicle 10 being an automobile having at least one battery system 14c that provides power to an electric motor of the automobile, the electric motor being the primary or secondary source of propulsion of the vehicle 10.

In operation, one or more sensors referred to generally as 22 sense observable conditions of the vehicle systems and/or the vehicle 10 and generate sensor signals based thereon. In various embodiments, the one or more vehicle systems 14a-14n generate signals and/or messages indicating conditions (e.g., determined parameters, diagnostic stats or codes, etc.) of the vehicle system 14a-14n and/or vehicle 10. The vehicle systems 14a-14n provide the signals and/or messages directly or indirectly through a communication bus (not shown) or other communication means (i.e., a telematics system that receive messages and/or signals from remote vehicles or infrastructure).

A control module 26 receives the signals from the sensors 22 and the signals and/or messages from the vehicle systems 14a-14n and determines a remaining useful life of the vehicle 10 or the sub-system 14a-14n. The control module 26 can be located on the vehicle 10, remote from the vehicle 10, or partly on the vehicle 10 and partly on a remote system (not shown). The control module 26 selectively notifies a user of the remaining useful life. In various embodiments, the control module 26 notifies the user through visual, audible, and/or haptic feedback provided by a notification system 28 within the vehicle 10 and/or through messages sent to remote devices (i.e., email messages, text messages, etc.) (not shown).

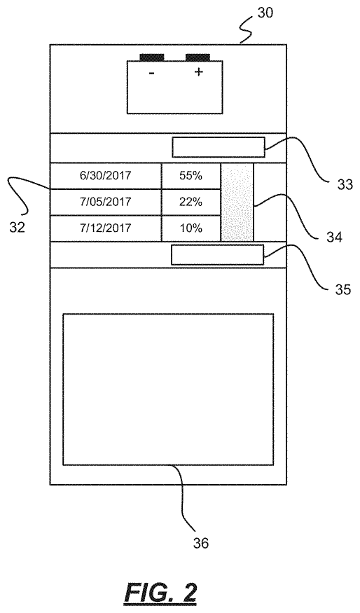

In various embodiments, the control module 26 permits configuration of the notification style by accepting user selection of a notification template from any number predefined notification templates. For example, as shown in FIGS. 2, 3, and 4, notification templates can be defined to visually present the remaining useful life information to the user in many different ways. The Figures illustrate remaining useful life data for the battery system 14c. As can be appreciated, the remaining useful life data can be presented for any sub-system 14a-14n.

FIG. 2 illustrates an exemplary notification template 30 that includes a text display box 32 for displaying a percent chance to survive and an associated date for a number of dates. The notification template 30 further includes a display box 36 for recommendations of nearby service centers. As further shown in FIG. 2, the notification template 30 can further include a graphical illustration 34 illustrating percent chances to survive graphically and a current date.

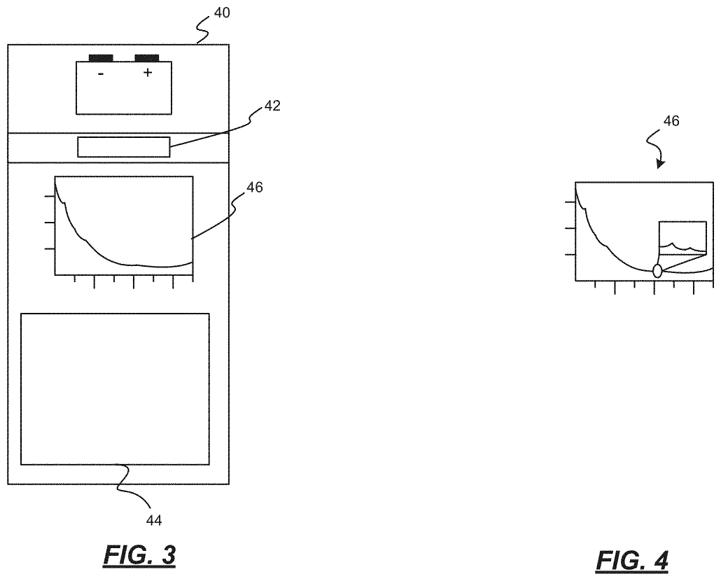

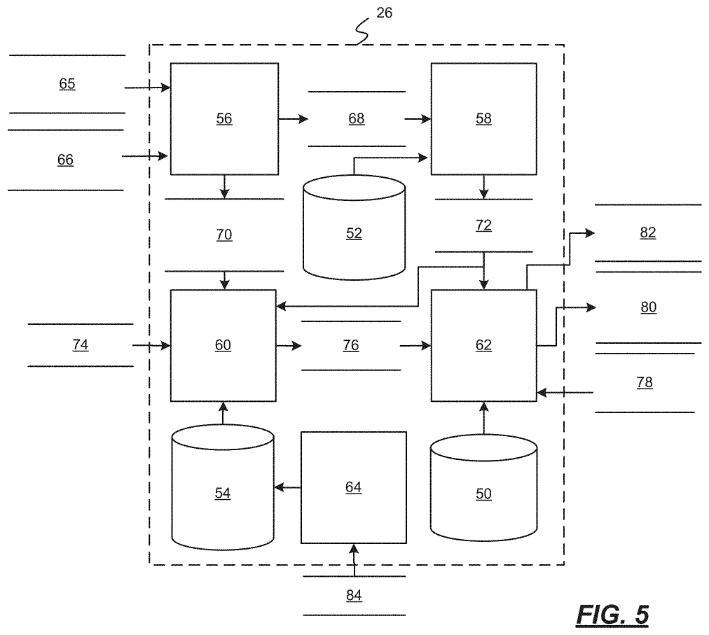

FIG. 3 illustrates an exemplary notification template 40 that includes a text display box 42 for displaying a number of days until a failure and a display box 44 for recommendations of nearby service centers. As further shown in FIG. 3, the notification template 40 can further include a graphical illustration of survival probabilities. As shown in FIG. 4, the graphical illustration 46 can be user selectable for zooming in on and displaying data for specific days. As can be appreciated, although certain examples are shown and discussed, the notification templates can be predefined to include any number of text display boxes and/or graphical displays and stored for user selection through the control module 26 in various embodiments.

Referring now to FIG. 5 and with continued reference to FIG. 1, a dataflow diagram illustrates various embodiments of the control module 26 in greater detail. Various embodiments of the control module 26 according to the present disclosure may include any number of sub-modules. As can be appreciated, the sub-modules shown in FIG. 5 may be combined and/or further partitioned to similarly monitor the vehicle 10 and/or vehicle sub-systems 14a-14n. Inputs to the control module 26 may be received from the sensors 22, received from the vehicle sub-systems 14a-14n, received from other control modules (not shown) of the vehicle 10, and/or determined by other sub-modules (not shown) of the control module 26. In various embodiments, the control module 26 includes a notification template datastore 50, a vehicle heath model datastore 52, a remaining useful life model datastore 54, a vehicle data collection module 56, a vehicle health monitoring module 58, a remaining useful life monitoring module 60, a notification determination module 62, and a model adaptation module 64.

The notification template datastore 50 stores the various templates for presenting remaining useful life information to a user. A user can select which of the various templates to be the default template. In various embodiments, the stored notification templates can include, but are not limited to, the templates 30, 40 shown in FIGS. 2, 3, and 4. As can be appreciated, other notification templates can be stored in various embodiments.

The vehicle health model datastore 52 stores at least one vehicle health model for diagnosing the health of the vehicle 10 or a vehicle component. In various embodiments, the vehicle health model is a model that identifies potential issues and classifies the health as either healthy or unhealthy based on a status of certain vehicle parameters (e.g., as shown in FIG. 7). The vehicle health model can be a physical model, a data driven model, or a machine learning model. When potential issues are identified, the vehicle health model initiates a proactive alert.

The remaining useful life model datastore 54 stores at least one remaining useful life health (RULh) model for predicting the remaining useful life of a healthy or healthy vehicle or vehicle component, and at least one remaining useful life alert (RULa) model for predicting the remaining useful life of an unhealthy or unhealthy vehicle or vehicle component. As shown in the exemplary graphs of FIG. 8, the RULh models are performed before the proactive alert is initiated; and the RULa models are performed after the proactive alert (PA) is initiated.

In various embodiments, as further illustrated in FIG. 8, the stored models RULh and RULa predict survival times using a proportional hazards model or some other survival model. For example, a hazard function λ(t|X) can be used that describes a hazard from a starting time to a current time given vehicle features X (e.g., model year, engine type, driving locations, etc.):

λ(t|X)=λ₀(t)exp(β₁X₁+β₂X₂+β₃X₃+ . . . ) (1)

Where λ₀(t)s represents the baseline hazard function for all vehicles. βi represents coefficients for the vehicle features to quantify the feature effect in the model. The hazard function λ₀(t)s is integrated to provide a survival function of the vehicle:

S(t|X)==exp(−∫λ(u|X)du). (2)

The area under the survival function is then computed to determine the average survival time of the vehicle:

RUL(X)=∫S(u|X)udu). (3)

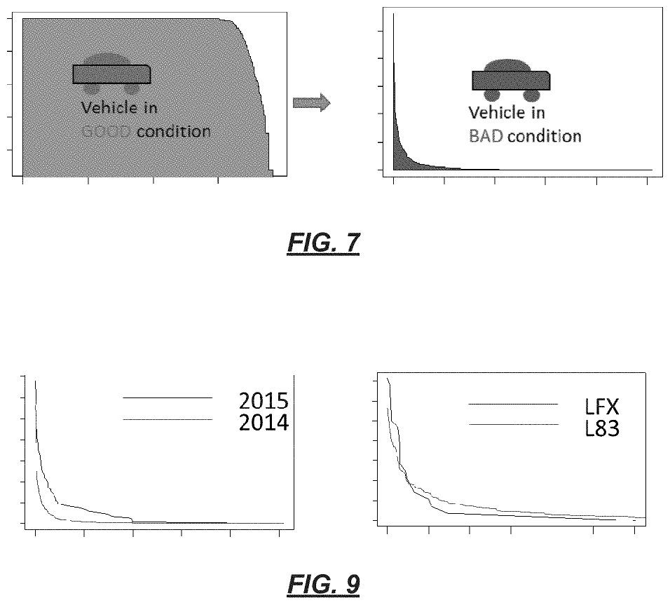

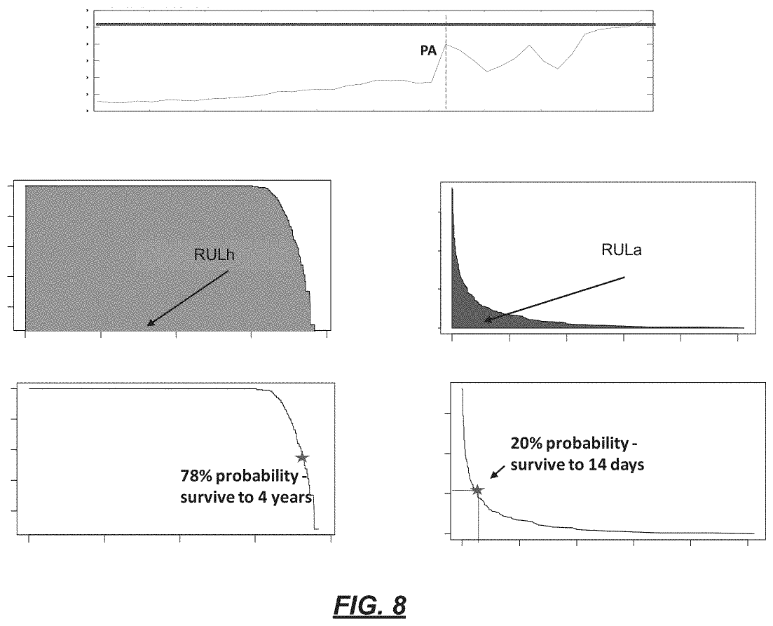

In various embodiments, as shown in FIG. 9, RULa models and RULh models can be provided for various vehicle configurations, for example, based on model year, engine type, vehicle type (e.g., sport utility, sedan, sports, etc.), engine type, etc.

With reference back to FIG. 5, the model adaptation module 64 updates the coefficients βi using a maximum likelihood function:

β=arg_{β}max L(β|0). (4)

Where L(β|O) is the likelihood of the coefficient 13 given all observations O. In various embodiments, the coefficients are updated based on service event data 84 generated by the vehicle 10 and/or service event data 84 generated by and received from other vehicles or from vehicle warranty systems and/or dealership systems. In various embodiments, the event data 84 can include time information associated with the vehicle health.

In various embodiments, the vehicle data collection module 56 collects vehicle data for monitoring the vehicle health and/or the remaining useful life. For example, the vehicle data collection module 56 receives diagnostic codes and/or messages 65, sensed vehicle parameters 66, etc. and provides the collected data as vehicle remaining useful life data 70 and vehicle health data 68.

In various embodiments, the vehicle health monitoring module 58 receives the vehicle health data 68 and determines the health of the vehicle 10. For example, the vehicle health monitoring module 58 selects one of the vehicle health models from the vehicle health model datastore 52 and processes the vehicle health data with the vehicle health model in order to classify the vehicle health condition as healthy or unhealthy. The vehicle health monitoring module 58 generates vehicle condition data 72 that indicates the health classification of the vehicle 10.

In various embodiments, the remaining useful life monitoring module 60 monitors the vehicle remaining useful life data 70 to determine a remaining useful life of the vehicle 10 or vehicle component. For example, the remaining useful life monitoring module 60 selects one of the vehicle RULh models or one of the vehicle RULa models from the vehicle health model datastore 54 and processes the vehicle remaining useful life data 70 with the selected model in order to determine survival data 76.

In various embodiments, the model is selected based on the condition data 72 provided by the vehicle health monitoring module. For example, when the condition data indicates that the condition of the vehicle 10 or vehicle component is good or healthy or that a proactive alert has not been generated, the remaining useful life monitoring module 60 retrieves a RULh model from the remaining useful life model datastore 54. In another example, when the condition data 72 indicates that the condition of the vehicle 10 or vehicle component is bad or unhealthy or that a proactive alert has been generated, the remaining useful life monitoring module 60 retrieves a RULa model from the remaining useful life model datastore 54. In various embodiments, the model is retrieved based on vehicle data 74, such as, but not limited to, model year, vehicle type, engine type, etc.

In various embodiments, the notification generation module 62 receives as input the condition data 72 and the survival data 76. Based on the inputs, the notification generation module 62 selectively generates proactive alert data 82 and/or survival notification data 80 to notify the user of the condition and survival time. In various embodiments, the notification generation module 62 generates the proactive alert data 82 and/or the survival notification data 80 based on the notification template selected by a user. For example, the notification generation module 62 receives user selection data 78 (e.g., provided as a result of a user interacting with a user interface) and retrieves the notification template from the notification template datastore 50. The notification generation module 62 then populates the retrieved template with the survival data 76 and/or the condition data 72.

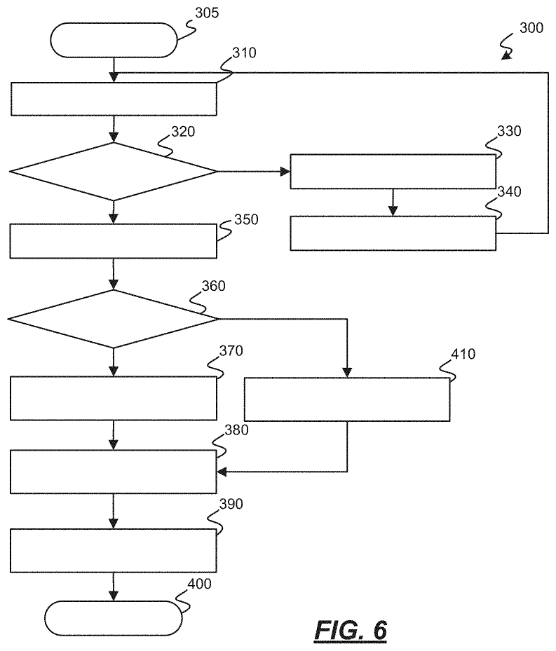

Referring now to FIG. 6, and with continued reference to FIGS. 1-5, a flowchart illustrates a method 300 that can be performed by the monitoring system 12 in accordance with various embodiments. As can be appreciated in light of the disclosure, the order of operation within the method 300 is not limited to the sequential execution as illustrated in FIG. 6, but may be performed in one or more varying orders as applicable and in accordance with the present disclosure.

As can further be appreciated, the method of FIG. 6 may be scheduled to run at predetermined time intervals during operation of the vehicle 10 and/or may be scheduled to run based on predetermined events.

In one example, as shown in FIG. 6, the method 300 may begin at 305. Vehicle data 65, 66, 84 is collected at 310. It is determined, from the vehicle data 65, 66, 84 whether a service event has occurred at 320. If, at 320 a service event has occurred, the event data 84 is communicated to a central processing system and/or stored at 330. The RUL models are then updated based on the event data at 340 and stored. Thereafter, the method continues to monitor for vehicle data 65, 66, 84 at 310.

If, at 310, an event has not been observed or the RUL models have already been updated based on an event, the vehicle health model is selected and performed on the vehicle health data 68 at 350 to classify the vehicle health as healthy or unhealthy. If, the classification of the vehicle health requires an alert (e.g., the health is classified as unhealthy) at 360, then the RULa model is selected and performed on the vehicle remaining useful life data 70 to determine the survival data 76 at 370. The notification template selected by the user is then retrieved and populated with the computed survival data 76 at 380; and the populated template is displayed to the user at 390. Thereafter, the method may end at 400.

If, at 360, the classification of the vehicle health does not require an alert (e.g., the health is classified as healthy), then the RULh model is selected and performed on the vehicle remaining useful life data 70 to determine the survival data 76 at 410. The notification template selected by the user is then retrieved and populated with the computed survival data 76 at 380; and the populated template is displayed to the user at 390. Thereafter, the method may end at 400.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof

What is claimed is:

1. A method of monitoring a first vehicle, the method comprising:
receiving data including at least one of vehicle parameters and vehicle diagnostic data;
determining, by a processor, a vehicle condition based on a model of vehicle health and the received data;
determining, by the processor, remaining useful life data associated with the vehicle based on a first statistical model when the vehicle condition is determined to be healthy;
determining, by the processor, remaining useful life data associated with the vehicle based on a second statistical model when the vehicle condition is determined to be unhealthy; and
selectively generating, by the processor, notification data based on the vehicle condition and the remaining useful life data.

2. The method of claim 1, further comprising updating the second statistical model based on service event data from the first vehicle.

3. The method of claim 1, further comprising updating the second model based on service event data collected from at least one other vehicle.

4. The method of claim 1, further comprising presenting the notification data based on a user selected notification template.

5. The method of claim 4, further comprising storing a plurality of notification templates and wherein the user selected notification template is selected from the plurality of notification templates based on user selection data.

6. The method of claim 1, wherein the first statistical model and the second statistical model are based on a proportional hazards model.

7. The method of claim 6, further comprising adapting at least one coefficient of the proportional hazards model based on event data from the first vehicle and other vehicles.

8. The method of claim 1, wherein the notification data includes a percent chance to survive and an associated date.

9. The method of claim 1, wherein the notification data includes a failure day.

10. The method of claim 1, wherein the notification data includes a graph of survival probabilities.

11. A computer implemented system for monitoring a vehicle, comprising:
a data storage device configured to store a model for determining a vehicle health condition, a first statistical model for computing remaining useful life data, and a second statistical model for computing remaining useful life data.
a processor configured to receive data including at least one of vehicle parameters and vehicle diagnostic data, determine a vehicle condition based on the model and the received data, determine remaining useful life data associated with the vehicle based on the first statistical model when the vehicle condition is determined to be healthy, determine remaining useful life data associated with the vehicle based on the second statistical model when the vehicle condition is determined to be unhealthy, and selectively generate notification data based on the vehicle condition and the remaining useful life data.

12. The system of claim 11, wherein the processor is further configured to update the second statistical model based on service event data from the first vehicle.

13. The system of claim 11, wherein the processor is further configured to update the second statistical model based on service event data collected from at least one other vehicle.

14. The system of claim 11, wherein the processor is further configured to present the notification data based on a user selected notification template.

15. The system of claim 14, wherein the data storage device is further configured to store a plurality of notification templates and wherein the user selected notification template is selected from the plurality of notification templates based on user selection data.

16. The system of claim 11, wherein the first statistical model and the second statistical model are based on a proportional hazards model.

17. The system of claim 16, wherein the processor is further configured to adapt at least one coefficient of the proportional hazards model based on event data from the first vehicle and other vehicles.

18. The system of claim 11, wherein the notification data includes a percent chance to survive and an associated date.

19. The system of claim 11, wherein the notification data includes a failure day.

20. The system of claim 11, wherein the notification data includes a graph of survival probabilities.
